(19) United States
(12) Patent Application Publication
(10) Pub. No.: US 2016/0149787 A1
(43) Pub. Date: May 26, 2016

(54) DATA TRANSMISSION SYSTEM, DATA TRANSMISSION MONITORING METHOD, AND COMPUTER-READABLE MEDIUM

(71) Applicant: VIVOTEK INC., New Taipei City (TW)

(72) Inventor: Pang-Ting Liao, New Taipei City (TW)

(21) Appl. No.: 14/941,684

(22) Filed: Nov. 16, 2015

(30) Foreign Application Priority Data
Nov. 24, 2014 (TW) 103140663

(51) Int. Cl. H04L 12/26; H04L 12/24

(52) U.S. Cl. CPC H04L 43/0894; H04L 43/067; H04L 41/0631; H04L 43/16

(57) ABSTRACT

A method of monitoring data transmission is applied to a data transmission system which includes at least one server device and a client device, each of which is linked to a telecommunications network. The at least one server device is used for generating a data stream and a data generation rate relative to the data stream. The data stream and the data generation rate are transmitted to the client device over the telecommunications network. The client device calculates a data receiving rate of data received from the data stream by the client device, and determines whether a comparison result of the data receiving rate with the data generation rate meets a predetermined condition. If YES, the client device generates a warming signal.

### BACKGROUND OF THE INVENTION

1. Field of the Invention

The invention relates to a data transmission system and a data transmission monitoring method, and especially relates to a system of transmitting data over a telecommunications network and a method thereof.

2. Description of the Prior Art

Various instant messaging applications through computer networks are practicable because of an increasingly wider communication bandwidth. In actual applications, a communication jam leading to a failure in operation of an instant messaging application may occur due to an instantaneous huge data on the route or an unstable network node in the route. When a communication jam occurs, a data receiving terminal cannot receive entire data in time for further processing even though a data source end has sent the data completely. For applications of instant monitoring, it is demanded to transmit data continuously. When a communication jam occurs, except that the data receiving terminal is unable to receive whole data in time, data to be transmitted also heap up, which makes the communication jam worse. Current data transmission mechanisms can be categorized roughly into reliable delivery (such as TCP) and unreliable delivery (such as UDP), either of which will not determine transmission quality of the received data until the data is received completely and processed (e.g. for statistics about packet delay and/or packet loss), even when a communication jam exists. Therefore, the two kinds of transmission mechanisms cannot quickly detect the existence of an unacceptable communication jam for any improvement in communication quality.

### SUMMARY OF THE INVENTION

An objective of the invention is to provide a data transmission system which transmits a data generation rate to a client device so that during receiving data, the client device can automatically compare the data generation rate with statistics of the received data and quickly determine the transmission quality of the data for an improvement in communication quality.

A data transmission system according to the invention includes at least one server device and a client device. The at least one server device and the client device are linked to a telecommunications network. The at least one server device is used for generating a data stream and a data generation rate relative to the data stream. The at least one server device transmits the data stream and the data generation rate to the client device over the telecommunications network. The client device compares the data generation rate with a data receiving rate of receiving data from the data stream. If a comparison result of the data receiving rate with the data generation rate meets a predetermined condition, the client device generates a warming signal. Thereby, the client device can automatically and quickly determine the transmission quality of the data by comparing the data generation rate with the data receiving rate.

Another objective of the invention is to provide a data transmission monitoring method which is to transmit a data generation rate to a client device so that during receiving data, the client device can automatically compare the data generation rate with statistics of the received data and quickly determine the transmission quality of the data for an improvement in communication quality.

A data transmission monitoring method according to the invention is used in a data transmission system. The data transmission system includes a telecommunications network, a client device, and at least one server device. The client device and the at least one server device are linked to the telecommunications network. The transmission monitoring method includes the following steps: receiving a data stream and a data generation rate relative to the data stream, which are generated by the at least one server device; calculating a data receiving rate of data received from the data stream by the client device; comparing the data generation rate with the data receiving rate; judging whether a comparison result of the data receiving rate with the data generation rate meets a predetermined condition; and if the comparison result meets the predetermined condition, generating a warming signal. Thereby, the data transmission monitoring method can automatically and quickly determine the transmission quality of the data by comparing the data generation rate with the data receiving rate.

Another objective of the invention is to provide a computer-readable medium recording instructions which are executed on a client device, linked to a telecommunications network to which at least one server device are linked, for implementing the data transmission monitoring method mentioned above.

Compared with the prior art, the invention monitors the transmission quality based on the variation of generation/receipt of the data over time, so the invention can determine the transmission quality in a relatively short time (e.g. relative to a time interval required for producing statistics about packet delay and packet loss by a conventional method in the prior art) so that an improvement in the communication quality can be made quickly (e.g. triggered by the warming signal).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a data transmission system of an embodiment according to the invention.

FIG. 2 is a flow chart of a data transmission monitoring method applied to the data transmission system according to the invention in FIG. 1.

FIG. 3 is a detailed flow chart of the flow chart in FIG. 2.

FIG. 4 is a functional block diagram of a server device of the data transmission system in FIG. 1.

FIG. 5 is a schematic diagram illustrating a data transmission system of another embodiment according to the invention.

FIG. 6 is a flow chart of a data transmission monitoring method applied to the data transmission system according to the invention in FIG. 5.

### DETAILED DESCRIPTION

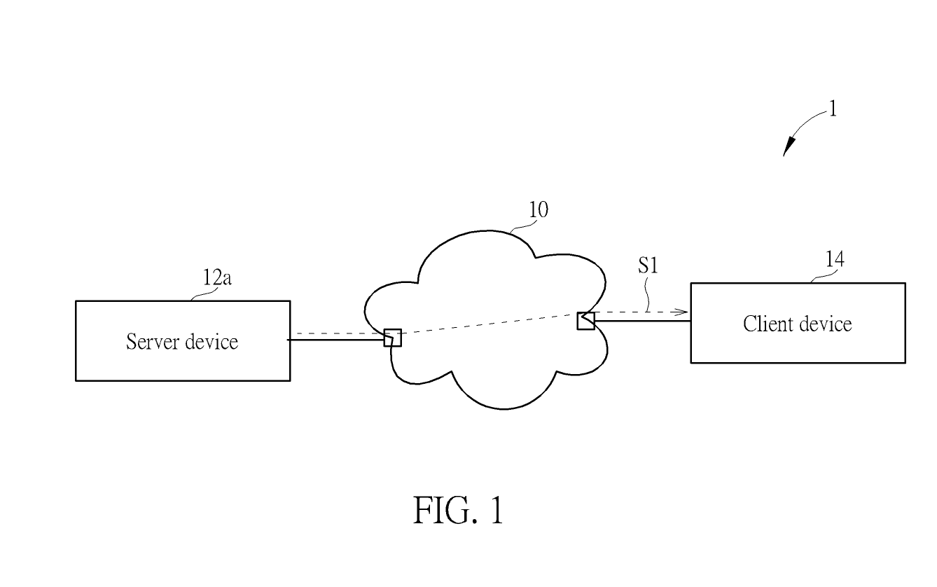

Please refer to FIG. 1 that is a schematic diagram illustrating a data transmission system 1 of an embodiment according to the invention. The data transmission system 1 includes a server device 12a and a client device 14 which are linked to a telecommunications network 10. Therein, the telecommunications network 10 is not limited to a single network topology or communications technology, and can be a hybrid network in practice. The server device 12a is used for generating a data stream S1 (indicated by a dashed line with an arrow in FIG. 1) and a data generation rate relative to the data stream S1. For example, the data generation rate can be a value of an amount of data, processed into the data stream S1 in a time period, divided by the time period. The server device 12a can transmit the data stream S1 and the data generation rate to the client device 14 over the telecommunications network 10. Therein, the data generation rate can be embedded into the data stream S1 and transmitted together (i.e. transmitted through the same communication channel), or the data generation rate is transmitted through another communication channel different to that for the data stream S1. Furthermore, in practice, the communication channel used for the above data transmission (for both the data stream S1 and the data generation rate) can be but not limited to routes used for TCP or UDP connection.

The client device 14 receives the data stream S1 and the data generation rate through the telecommunications network 10. The client device 14 compares the data generation rate with a data receiving rate of data received from the data stream S1 by the client device 14. If a comparison result of the data receiving rate with the data generation rate meets a predetermined condition, the client device 14 generates a warming signal. Therein, in practice, the server device 12a periodically generates the data generation rate by a predetermined time interval; that is, in principle, the client device 14 receives the data generation rate and implements the above comparison every the predetermined time interval. The predetermined condition can be determined depending on an application of the data transmission system 1. For example, the predetermined condition includes the data receiving rate being less than the data generation rate by successive N times; therein, N is a positive integer greater than or equal to 1. In other words, the warming signal is generated when the times of the data receiving rate being insufficient reach a certain value (e.g. when a communication jam continues for a certain period of time); therein, the times (i.e. the value of N) can be a default value or set by user. For another example, the predetermined condition includes the data receiving rate being less than or equal to a threshold value. The threshold value is M times of the data generation rate; therein, M is a positive real number less than 1.0. In other words, the warming signal is generated when the degree of the data receiving rate being insufficient reaches a certain extent (e.g. when a communication jam is worse); therein, the threshold value (i.e. the value of M) can be a default value or set by user. For another example, the predetermined condition includes an intersection set (simultaneously occurring) or union set (alternatively occurring) of the above two conditions. Furthermore, the warming signal can be a flashing spot or icon on a screen (not shown in the figure) of the client device 14, or a triggering signal for triggering other functions.

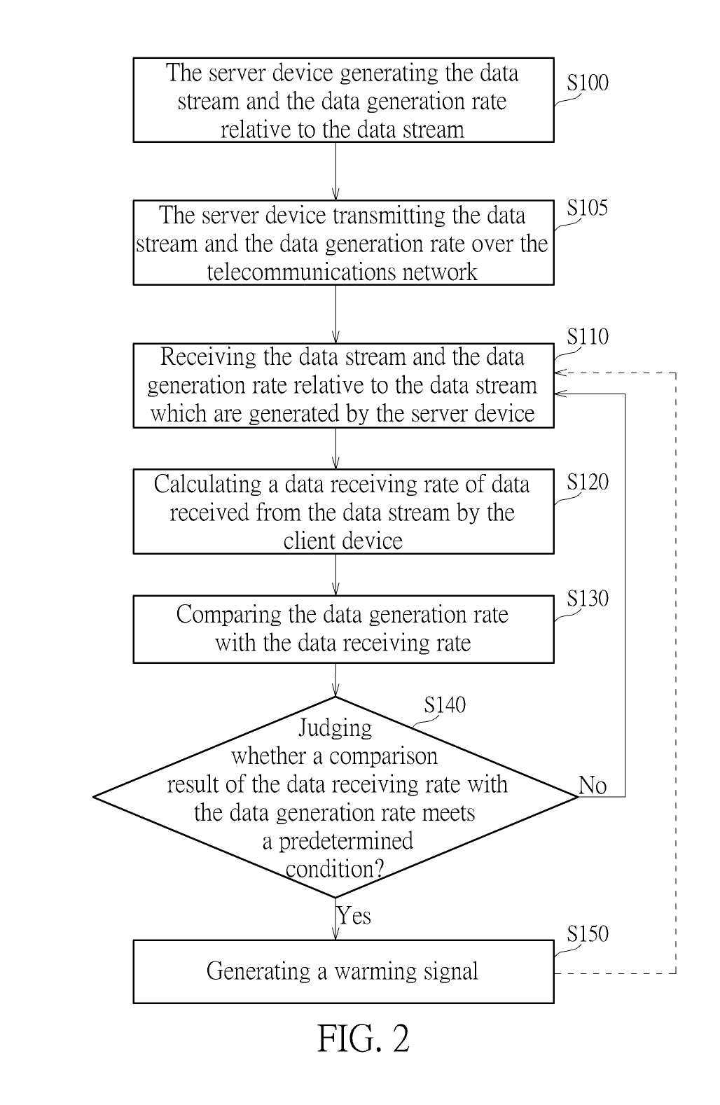

Please also refer to FIG. 2. FIG. 2 is a flow chart of a data transmission monitoring method applied to the data transmission system 1 according to the invention. The data transmission monitoring method includes receiving the data stream S1 and the data generation rate relative to the data stream S1 which are generated by the server device 12a, as shown by the step S110; then, calculating a data receiving rate of data received from the data stream S1 by the client device 14, as shown by the step S120; comparing the data generation rate (in the step S110) with the data receiving rate (in the step S120), as shown by the step S130; judging whether a comparison result of the data receiving rate with the data generation rate (i.e. a result of the comparing in the step S130) meets a predetermined condition, as shown by the step S140; and if the comparison result meets the predetermined condition (i.e. if the judgment in the step S140 is YES), generating a warming signal, as shown by the step S150. In practice, all the steps S110, S120, S130, S140 and S150 can be implemented on client device 14, or the client device 14 implements the steps S110 and S120 while the data generation rate (in the step S110) and the data receiving rate (in the step S120) are provided to a third-party device, and then the third-party device implements the steps S130, S140 and S150; however, the invention is not limited thereto. By the above method, the invention can determine the transmission quality before the client device 14 processes the content of the received data (e.g. decoding).

Furthermore, in practice, the data transmission monitoring method includes before the step S110, the server device 12a generating the data stream S1 and the data generation rate relative to the data stream S1, as shown by the step S100; the server device 12a transmitting the data stream and the data generation rate over the telecommunications network 10, as shown by the step S105. Therein, in the step S105, the server device 12a can transmit the data stream S1 and the data generation rate through the same or distinct communication channels; in the step S110, the client device 14 receives the data stream S1 and the data generation rate through the same or distinct communication channels correspondingly. Furthermore, in the step S100, the server device 12a generates periodically generates the data generation rate by a predetermined time interval; that is, in principle, the client device 14 receives the data generation rate and implements the steps of calculating and comparing (as shown by the steps S110, S120 and S130) every the predetermined time interval.

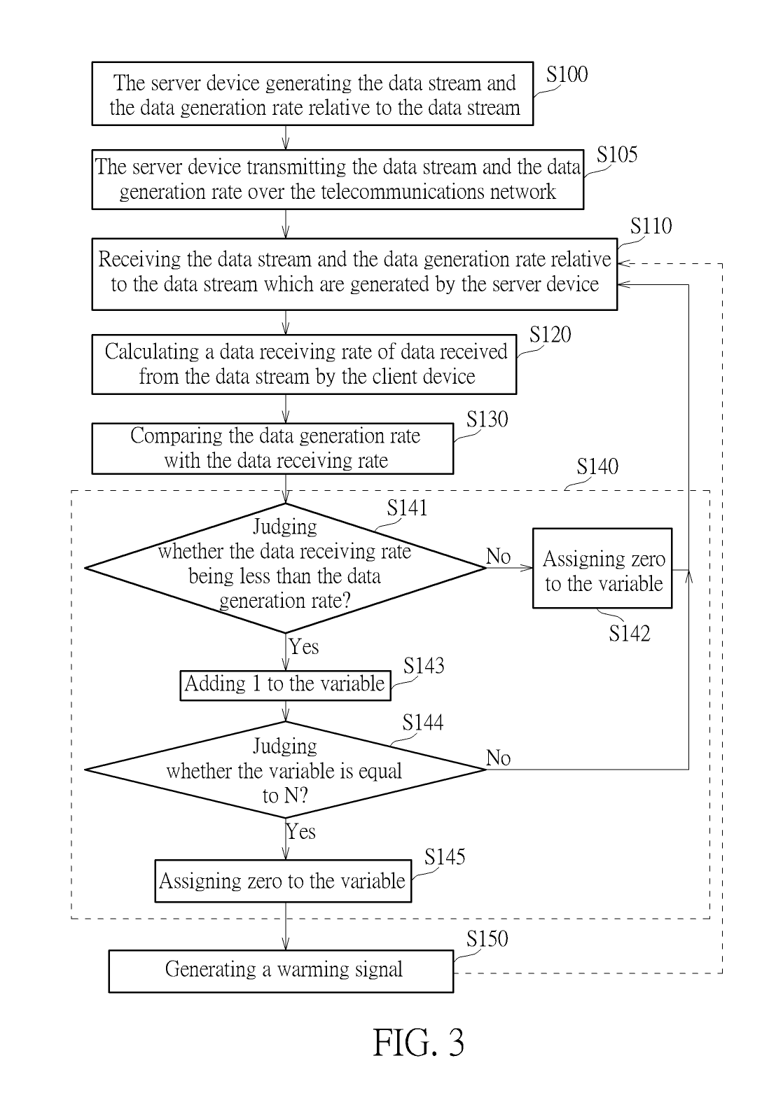

In addition, in the step S140, the judgment depends on the predetermined condition. For example, the step S140 is to judge whether the data receiving rate is less than the data generation rate by successive N times; therein, N is a positive integer greater than or equal to 1. For another example, the step S140 is to judge whether the data receiving rate is less than or equal to a threshold value. The threshold value is M times of the data generation rate; therein, M is a positive real number less than 1.0. For other descriptions, please refer to the relevant descriptions about the predetermined condition for the data transmission system 1, which will not be repeated in addition. It is added that if the comparison result (in the step S140) does not meet the predetermined condition, the flow of the flow chart returns to the step S110 for next steps of receiving, calculating, comparing and judging. After the step S150, the flow of the flow chart can point to a process or/and return to the step S110 for next steps of receiving, calculating, comparing and judging (as indicated by a flow path of a dashed line with an arrow in FIG. 2). For other descriptions about the data transmission monitoring method, please refer to the relevant descriptions for the data transmission system 1, which will not be repeated in addition. Therein, for cases that the predetermined condition depends on an accumulation of times (such as the above embodiment of judging whether the data receiving rate being less than the data generation rate by N times), the step S140 in FIG. 2 can be detailed further as the flow chart shown by FIG. 3. In FIG. 3, the step S140 is implemented by the steps S141-S145. The accumulation of times is implemented by a variable for accumulating of times. As shown in FIG. 3, the data transmission monitoring method includes judging whether the data receiving rate being less than the data generation rate, as shown by the step S141. If the judgment of the step S141 is NO, zero is assigned to the variable, as shown by the step S142. Then, the flow returns to the step S110. If the judgment of the step S141 is YES, 1 is added to the variable, as shown by the step S143. Then, the data transmission monitoring method is to judge whether the variable is equal to N, as shown by the step S144. If the judgment of the step S144 is No, the flow returns to the step S110. If the judgment of the step S144 is YES, zero is assigned to the variable, as shown by the step S145. Then, the flow points to the step S150.

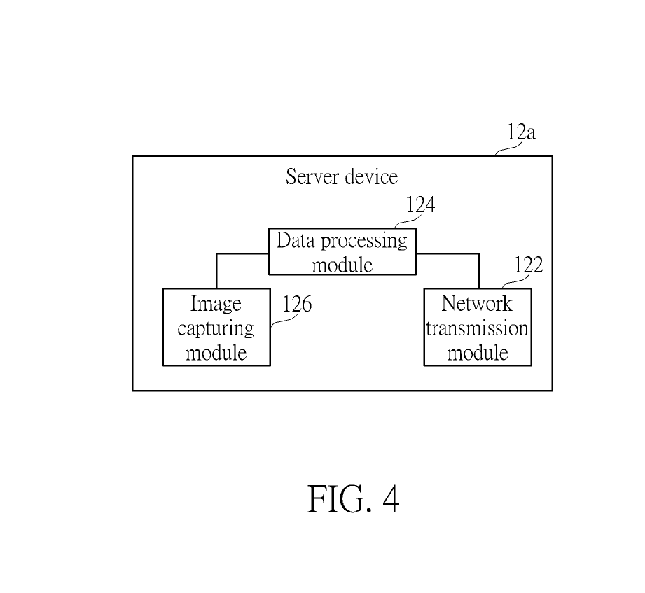

Please also refer to FIG. 4. FIG. 4 is a functional block diagram of the server device 12a of an embodiment. In the embodiment, the server device 12a includes a network transmission module 122, a data processing module 124, and an image capturing module 126. The network transmission module 122 (e.g. a network card) is linked to the telecommunications network 10. The data processing module 124 is coupled to the network transmission module 122 and the image capturing module 126. The image capturing module 126 serves as a data resource of the data processing module 124. In the embodiment, the server device 12a can be camera equipment (such as a network camera), but not limited thereto. Furthermore, the configuration of the server device according to the invention is not limited to the above configuration. The server device 12a uses the data processing module 124 to process data from the data resource (i.e. the image capturing module 126) to generate the data stream S1 and the data generation rate according to the processed data. The data stream S1 and the data generation rate are transmitted to the client device 14 over the network transmission module 10.

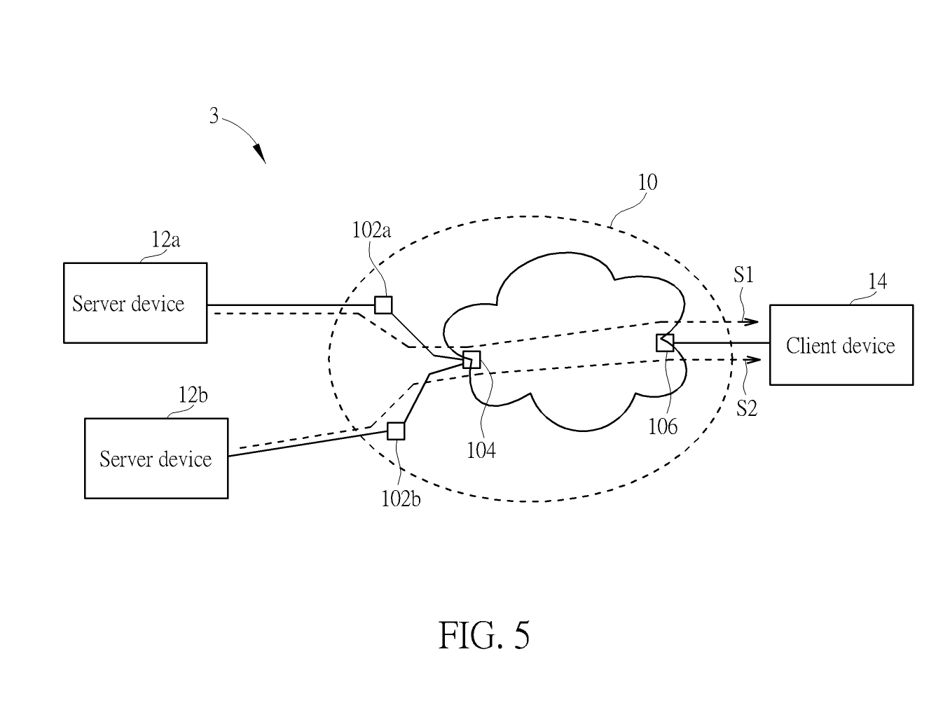

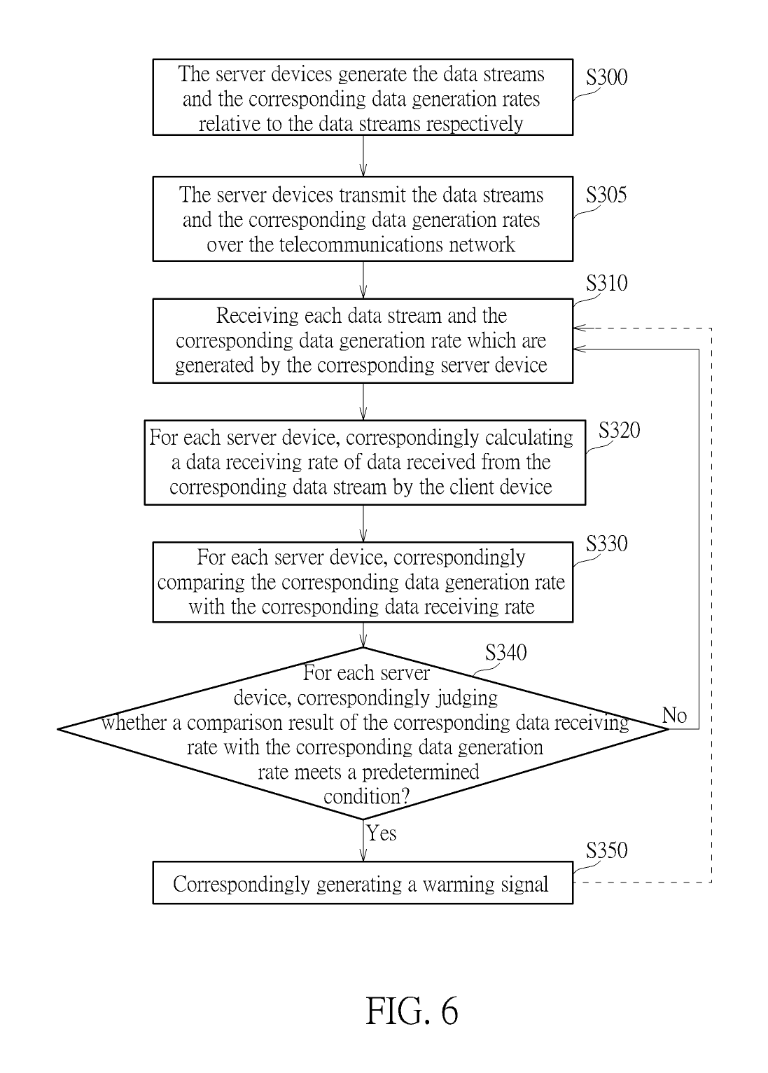

Please refer to FIG. 5 and FIG. 6. FIG. 5 is a schematic diagram illustrating a data transmission system 3 of another embodiment according to the invention. FIG. 6 is a flow chart of a data transmission monitoring method applied to the data transmission system 3 according to the invention. The data transmission system 3 and the data transmission system 1 are substantially the same in configuration. A difference between the data transmission system 3 and the data transmission system 1 is that the data transmission system 3 includes a server device 12b except for the server device 12a. The server device 12b is used for generating a data stream S2 (indicated by a dashed line with an arrow in FIG. 5) and a data generation rate relative to the data stream S2. The server device 12b can transmit the data stream S2 and the data generation rate relative to the data stream S2 to the client device 14 over the telecommunications network 10. The mechanism of transmitting data between the server device 12b and the client device 14 is the same as that between the server device 12a and the client device 14; therefore, for other descriptions about the server device 12b, please refer to the above relevant descriptions about the server device 12a, which will not be repeated in addition. Similarly, the server device 12b is not limited to camera equipment. In addition, in the embodiment, the data transmission system 3 shows only the two server devices 12a and 12b, but in practice, the data transmission system according to the invention can be applied to a case of more server devices. For details of the operation of such case, please refer to the relevant descriptions of the data transmission systems 1 and 3, which will not be described in addition.

In FIG. 6, the flow chart of the data transmission monitoring method applied to the data transmission system 3 is substantially similar to the flow chart in FIG. 2. FIG. 6 shows the flow chart for simultaneously monitoring several server devices 12a and 12b. As shown by FIG. 6, the data transmission monitoring method includes receiving each data stream S1 and S2 and the corresponding data generation rate which are generated by the corresponding server device 12a and 12b, as shown by the step S310; then, for each server device 12a and 12b, correspondingly calculating a data receiving rate of data received from the corresponding data stream S1 and S2 by the client device 14, as shown by the step S320; for each server device 12a and 12b, correspondingly comparing the corresponding data generation rate (in the step S310) with the corresponding data receiving rate (in the step S320), as shown by the step S330; for each server device 12a and 12b, correspondingly judging whether a comparison result of the corresponding data receiving rate with the corresponding data generation rate (i.e. a result of the comparing in the step S330) meets a predetermined condition, as shown by the step S340; and for each server device 12a and 12b, if the corresponding comparison result meets the predetermined condition, correspondingly generating a warming signal, as shown by the step S350. Therein, for each server device 12a and 12b, the corresponding predetermined condition for comparison can be set individually. For other descriptions about the predetermined condition, please refer to the relevant descriptions of the above embodiments, which will not be repeated in addition. Furthermore, the descriptions about the step S140 in FIG. 3 also can be applied to the step S340 in FIG. 6 (i.e. the predetermined condition depending on an accumulation of times) and will not be repeated. In a practical application, for example the server devices 12a and 12b are network cameras while the client device 14 is an image monitoring end. The client device 14 has a screen which shows images captured by the server devices 12a and 12b (i.e. by retrieving the content from the data streams S1 and S2 respectively) in different split windows thereon. When one comparison result meets the corresponding predetermined condition, the corresponding warming signal can be flashing the image, flashing or highlighting the frame of the corresponding window, displaying a flashing spot, a light indication or an icon in the corresponding window, or displaying a warning icon in the corresponding window, so that a watching person can be aware of it (and sets or informs the corresponding server device 12a and 12b to reduce the quality in capturing images for example). For other descriptions about the warming signal, please refer to the relevant descriptions of the above embodiments, which will not be repeated in addition.

Furthermore, in practice, before the step S310, the server devices 12a and 12b generate the data streams S1 and S2 and the corresponding data generation rates relative to the data streams S1 and S2 respectively, as shown by the step S300. The server devices 12a and 12b transmit the data streams S1 and S2 and the corresponding data generation rates over the telecommunications network 10, as shown by the step S305. Similarly, the flow chart shown by FIG. 6 is implemented repeatedly, so in the step S300, each server device 12a and 12b periodically generate the corresponding data generation rate relative to the corresponding data stream S1 and S2 by a predetermined time interval; that is, in principle, the client device 14 receives the data generation rates and implements the above steps of calculating, comparing and so on (as shown by the steps S310, S320 and S330) every the predetermined time interval. It is added that in practice, the server devices 12a and 12b are not limited to the same predetermined time interval. For other descriptions about the flow chart in FIG. 6, please refer to the relevant descriptions about the flow charts in FIG. 2 and FIG. 3, which will not be repeated.

In addition, in the embodiment, the telecommunications network 10 (the extent of which is indicated by a dashed circle) includes four network transmission apparatuses 102a, 102b, 104 and 106 (e.g. switches, gateways, routers) located as network nodes, as shown in FIG. 5. The server device 12a is linked to the telecommunications network 10 through the network transmission apparatuses 102a and 104. The server device 12b is linked to the telecommunications network 10 through the network transmission apparatuses 102b and 104. The client device 14 is linked to the telecommunications network 10 through the network transmission apparatus 106. In principle, the telecommunications network 10 includes networks connected in communication between the server devices 12a and 12b and the client device 14 (including intranet networks and at least one external network). The network transmission apparatuses 102a, 102b and 104 can be regarded as a portion of one intranet network. In practice, if the client device 14 generates a warming signal corresponding to the server device 12a but not to the server device 12b, the data transmission monitoring method is to determine that a transmission problem occurs in a communication channel through which the first server device 12a corresponding to the warming signal is linked. For most cases, the data streams S1 and S2 are transmitted in the same communication channel in the external network, so it is reasonable to infer that the network transmission apparatus 102a may have a transmission problem. It is convenient for a person of network management to deal with the network transmission apparatus 102a belonging to the intranet for recovering of the transmission quality, without modifying the setting of the data resource or the setting of the server device 12a for processing data leading to a reduction of the monitoring quality to the server device 12a. It is added that in practice, the data transmission monitoring method according to the invention can be implemented by software, firmware and so on. Therefore, in an embodiment, a computer-readable medium according to the invention records instructions which can be executed on the client device 14 for implementing the steps which are implemented on the client device 14 (such as the steps S110-S150 and S310-S350 in the above embodiments). The instructions can be packaged as an application program (such as including procedures or instructions capable of implementing the above steps). Thereby, after retrieving the application program from the computer-readable medium, the client device 14 can implement the data transmission monitoring method according to the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission system, comprising:
at least one server device linked to a telecommunications network, the at least one server device being used for generating a data stream and a data generation rate relative to the data stream; and
a client device linked to the telecommunications network, the at least one server device transmitting the data stream and the data generation rate to the client device over the telecommunications network, the client device comparing the data generation rate with a data receiving rate of receiving data from the data stream, the client device generating a warming signal if a comparison result of the data receiving rate with the data generation rate meets a predetermined condition.

2. The data transmission system of claim 1, wherein the at least one server device includes a network transmission module and a data processing module, the network transmission module is linked to the telecommunications network, the data processing module is coupled to the network transmission module, the data processing module processes data from a corresponding data resource to generate the data stream and generates the data generation rate according to the processed data, and the data stream and the data generation rate are transmitted through the network transmission module.

3. The data transmission system of claim 1, wherein the data generation rate is transmitted through a communication channel different to the data stream.

4. The data transmission system of claim 1, wherein the at least one server device generates the data generation rate every a predetermined time interval.

5. The data transmission system of claim 4, wherein the predetermined condition comprises the data receiving rate being less than the data generation rate by successive N times, and N is a positive integer greater than or equal to 1.

6. The data transmission system of claim 1, wherein the predetermined condition comprises the data receiving rate being less than or equal to a threshold value, the threshold value is M times of the data generation rate, and M is a positive real number less than 1.0.

7. A data transmission monitoring method for a data transmission system, the data transmission system comprising a telecommunications network, a client device, and at least one server device, the client device and the at least one server device being linked to the telecommunications network, the data transmission monitoring method comprising the following steps:
(a) receiving a data stream and a data generation rate relative to the data stream, which are generated by the at least one server device;
(b) calculating a data receiving rate of data received from the data stream by the client device;
(c) comparing the data generation rate with the data receiving rate;
(d) judging whether a comparison result of the data receiving rate with the data generation rate meets a predetermined condition; and
(e) if the comparison result meets the predetermined condition, generating a warming signal.

8. The data transmission monitoring method of claim 7, wherein the step (a) further comprises:
receiving the data generation rate through a communication channel different to the data stream.

9. The data transmission monitoring method of claim 7, the at least one server device comprising a first server device and a second server device, the data transmission monitoring method further comprising:
if the client device generates a warming signal corresponding to the first server device but not to the second server device, determining that a transmission problem occurs in a communication channel through which the first server device corresponding to the warming signal is linked.

10. The data transmission monitoring method of claim 7, wherein the step (a) further comprises:
the at least one server device generating the data generation rate every a predetermined time interval.

11. The data transmission monitoring method of claim 10, wherein the step (d) further comprising:
judging whether the data receiving rate is less than the data generation rate by successive N times, N being a positive integer greater than or equal to 1.

12. The data transmission monitoring method of claim 7, wherein the step (d) comprising:
judging whether the data receiving rate is less than or equal to a threshold value, the threshold value being M times of the data generation rate, M being a positive real number less than 1.0.

13. A computer-readable medium recording instructions, the instructions being executed on a client device, linked to a telecommunications network to which at least one server device are linked, for implementing the following steps:
(a) receiving a data stream and a data generation rate relative to the data stream, which are generated by the at least one server device;
(b) calculating a data receiving rate of data received from the data stream by the client device;
(c) comparing the data generation rate with the data receiving rate;
(d) judging whether a comparison result of the data receiving rate with the data generation rate meets a predetermined condition; and
(e) if the comparison result meets the predetermined condition, generating a warming signal.

14. The computer-readable medium of claim 13, wherein the step (a) further comprises:
receiving the data generation rate through a communication channel different to the data stream.

15. The computer-readable medium of claim 13, the at least one server device comprising a first server device and a second server device, the instructions further comprising:
if the client device generates a warming signal corresponding to the first server device but not to the second server device, determining that a transmission problem occurs in a communication channel through which the first server device corresponding to the warming signal is linked.

16. The computer-readable medium of claim 13, wherein the step (a) further comprises:
the at least one server device generating the data generation rate every a predetermined time interval.

17. The computer-readable medium of claim 16, wherein the step (d) further comprising:
judging whether the data receiving rate is less than the data generation rate by successive N times, N being a positive integer greater than or equal to 1.

18. The computer-readable medium of claim 13, wherein the step (d) comprising:
judging whether the data receiving rate is less than or equal to a threshold value, the threshold value being M times of the data generation rate, M being a positive real number less than 1.0.
